(19) United States
(12) Patent Application Publication
(10) Pub. No.: US 2008/0243480 A1
(43) Pub. Date: Oct. 2, 2008

(54) System and method for determining semantically related terms

(75) Inventors: Kevin Bartz, Cambridge, MA (US); Vijay Murthi, Glendale, CA (US); Shaji Sebastian, Pasadens, CA (US)

Correspondence Address: BRINKS HOFER GILSON & LIONE / YAHOO! OVERTURE, P.O. BOX 10395, CHICAGO, IL, 60610, US

(73) Assignee: YAHOO! Inc.

(21) Appl. No.: 11/731,396

(22) Filed: Mar. 30, 2007

(51) Int. Cl. G06F 17/27

(52) U.S. Cl. 704/9

(57) ABSTRACT

Systems and methods for determining semantically related terms are disclosed. Generally, a semantically related term tool receives a seed set and identifies a plurality of terms that constitute the seed set. For each term of the seed set, the semantically related term tool identifies concept terms associated with terms of the seed set other than the term being processed, joins the term being processed with each of the identified concept terms, and adds the resulting terms to a plurality of semantically related terms. The semantically related term tool removes invalid terms from the plurality of semantically related terms based on a language model and ranks at least a portion of the remaining terms of the plurality of semantically related terms based on a metric indicating a degree of semantical relationship between a term of the plurality of semantically related terms and one or more terms of the set seed.

### BACKGROUND

When advertising using an online advertisement service provider such as Yahoo! Search Marketing™, or performing a search using an Internet search engine such as Yahoo!™, users often wish to determine semantically related terms. Two terms, such as words or phrases, are semantically related if the terms are related in meaning in a language or in logic. Obtaining semantically related terms allows advertisers to broaden or focus their online advertisements to relevant potential customers and allows searchers to broaden or focus their Internet searches in order to obtain more relevant search results.

Various systems and methods for determining semantically related terms are disclosed in U.S. patent application Ser. Nos. 11/432,266 and 11/432,585, filed May 11, 2006 and assigned to Yahoo! Inc. For example, in some implementations in accordance with U.S. patent application Ser. Nos. 11/432,266 and 11/432,585, a system determines semantically related terms based on web pages that advertisers have associated with various terms during interaction with an advertisement campaign management system of an online advertisement service provider. In other implementations in accordance with U.S. patent application Ser. Nos. 11/432,266 and 11/432,585, a system determines semantically related terms based on terms received at a search engine and a number of times one or more searchers clicked on particular universal resource locators (“URLs”) after searching for the received terms.

Yet other systems and methods for determining semantically related terms are disclosed in U.S. patent application Ser. No. 11/600,698, filed Nov. 16, 2006, and assigned to Yahoo! Inc. For example, in some implementations in accordance with U.S. patent application Ser. No. 11/600,698, a system determines semantically related terms based on sequences of search queries received at an Internet search engine that are related to similar concepts.

It would be desirable to develop additional systems and methods for determining semantically related terms based on other sources of data.

### BRIEF DESCRIPTION OF THE DRAWINGS

FIG. 1 is a block diagram of one embodiment of an environment in which a system for determining semantically related terms may operate;

FIG. 2 is a block diagram of one embodiment of a system for determining semantically related terms;

FIG. 3 is a flow chart of one embodiment of a method for determining semantically related terms;

FIG. 4 is a flow chart of another embodiment of a method for determining semantically related terms;

FIG. 5 is a block diagram of another embodiment of a system for determining semantically related terms;

FIG. 6 is a flow chart of another embodiment of a method for determining semantically related terms; and

FIG. 7 is a flow chart of another embodiment of a method for determining semantically related terms.

### DETAILED DESCRIPTION OF THE DRAWINGS

The present disclosure is directed to systems and methods for determining semantically related terms. An online advertisement service provider (“ad provider”) may desire to determine semantically related terms to suggest new terms to online advertisers so that the advertisers can better focus or expand delivery of advertisements to potential customers. Similarly, a search engine may desire to determine semantically related terms to assist a searcher performing research at the search engine. Providing a searcher with semantically related terms allows the searcher to broaden or focus a search so that search engines provide more relevant search results to the searcher.

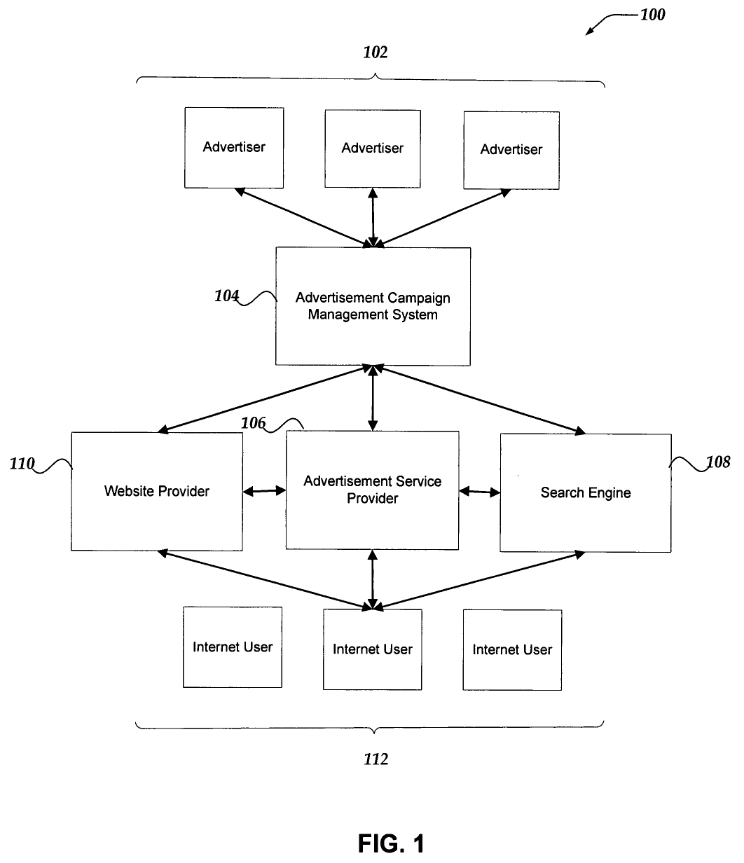

FIG. 1 is a block diagram of one embodiment of an environment in which a system for determining semantically related terms may operate. However, it should be appreciated that the systems and methods described below are not limited to use with a search engine or pay-for-placement online advertising.

The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may pay additional premiums for certain targeting options, such as targeting by demographics, geography, technographics or context. The digital ad may be a graphical banner ad that appears on a website viewed by Internet users 112, a sponsored search listing that is served to an Internet user 112 in response to a search performed at a search engine, a video ad, a graphical banner ad based on a sponsored search listing, and/or any other type of online marketing media known in the art.

When an Internet user 112 performs a search at a search engine 108, the ad provider 106 may serve one or more digital ads created using the ad campaign management system 104 to the Internet user 112 based on search terms provided by the Internet user 112. Also, when an Internet user 112 views a website served by the website provider 110, the ad provider 106 may serve one or more digital ads to the Internet user 112 based on keywords obtained from a website. When the digital ads are served, the ad campaign management system 104 and the ad provider 106 may record and process information associated with the served digital ads for purposes such as billing, reporting, or ad campaign optimization. For example, the ad campaign management system 104 and ad provider 106 may record the search terms that caused the ad provider 106 to serve the digital ads; whether the Internet user 112 clicked on a URL associated with the served digital ads; what additional digital ads the ad provider 106 served with the digital ad; a rank or position of a digital ad when the Internet user 112 clicked on the digital ad; and/or whether an Internet user 112 clicked on a URL associated with a different digital ad. One example of an ad campaign management system that may perform these types of actions is disclosed in U.S. patent application Ser. No. 11/413,514, filed Apr. 28, 2006, and assigned to Yahoo! Inc. It will be appreciated that the systems and methods for determining semantically related terms described below may operate in the environment of FIG. 1.

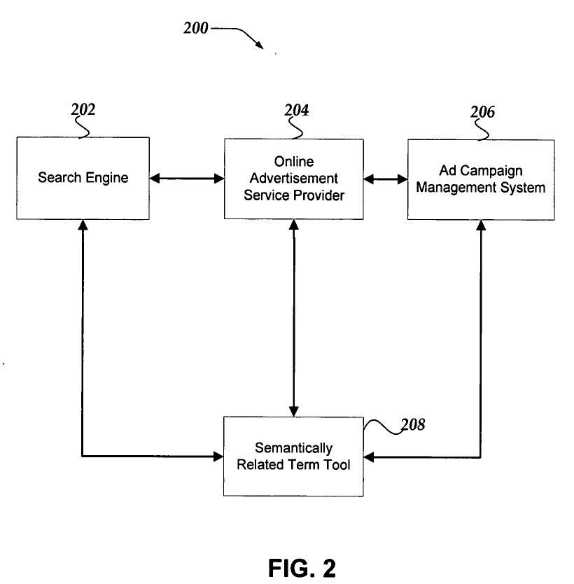

FIG. 2 is a block diagram of one embodiment of a system for determining semantically related terms. The system 200 may include a search engine 202, an ad provider 204, an advertisement campaign management system 206, and a semantically related term tool 208. In some implementations the semantically related term tool 208 may be part of the search engine 202, the ad provider 204, or the ad campaign management system 206, but in other implementations the semantically related term tool 208 is distinct from the search engine 202, the ad provider 204, and the ad campaign management system 206. The search engine 202, ad provider 204, ad campaign management system 206, and semantically related term tool 208 may communicate with each other over one or more external or internal networks. Further, the search engine 202, ad provider 204, ad campaign management system 206, and semantically related term tool 208 may be implemented as software code running in conjunction with a processor such as a single server, a plurality of servers, or any other type of computing device known in the art.

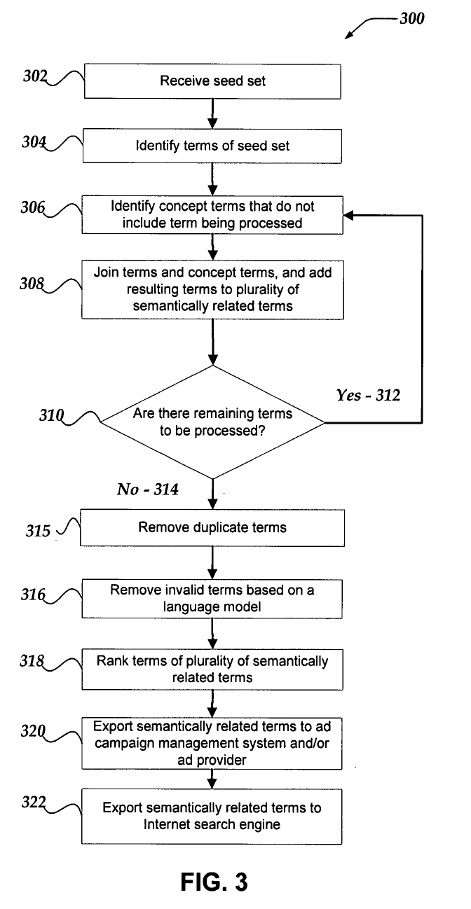

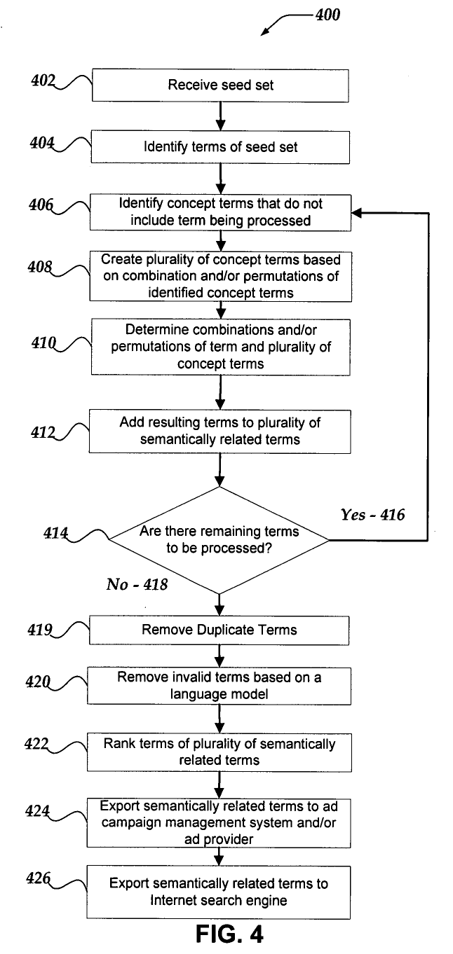

As described in more detail below, the search engine 202, the ad provider 204, or the ad campaign management system 206 receives a seed set including two or more terms, each of which may include one or more words or phrases. Generally, the seed set represents the types of terms for which the user or system submitting the seed set would like to receive additional terms having a similar meaning in logic or in a language. The semantically related term tool 208 identifies each term of the seed set. The semantically related term tool 208 then determines a plurality of semantically related terms based on concept terms within the seed set. A concept term refers to a term or phrase that when split apart loses its meaning. For example, with respect to the term “New York Pizza,” the concepts within the term are “New York”, “pizza” and “New York Pizza”. Breaking the term “New York” into “New,” or “York,” makes the term lose its meaning. The semantically related term tool 208 removes any invalid terms from the determined plurality of semantically related terms based on a language model. For example, the semantically related term tool 208 may remove each term from the plurality of semantically related terms that is associated with a search volume below a predetermined threshold. The semantically related term tool 208 then ranks at least a portion of the remaining terms of the plurality of semantically related terms to determine one or more terms that are closely related to one or more terms of the seed set. Two methods for determining terms semantically related to a seed set are described below with respect to FIGS. 3 and 4.

FIG. 3 illustrates a flow chart for one embodiment of a method for determining terms semantically related to a seed set by joining terms of the seed set with concept terms within the seed set. The method 300 begins with a search engine, an ad provider, or an ad campaign management system receiving a seed set at step 302. The seed set may be a search query submitted to a search engine by an Internet user, a series of search queries submitted to a search engine by an Internet user that are related to similar concepts, a bidded phrase submitted by an advertiser interacting with an advertisement campaign management system of an ad provider, a keyword received from a website provider with an ad request, or any other set of terms submitted to a search engine, an ad provider, or an ad campaign management system. The seed set comprises two or more terms, each of which may include one or more words or phrases. For example, a search engine or an ad provider may receive a seed set “N.Y. pizza, fast delivery, cheap delivery” including a first term “N.Y. pizza,” a second term “fast delivery,” and a third term “cheap delivery.”

The semantically related term tool identifies the terms that constitute the seed set at step 304. In some implementations, the semantically related term tool may identify terms of the seed set based on punctuation such as commas within the seed set, where in other implementations the semantically related term tool may identify terms of the seed set based on spaces within the seed set. Examples of systems and methods for determining terms that constitute a seed set are described in U.S. patent application Ser. No. 10/713,576 (now U.S. Pat. No. 7,051,023), filed Nov. 12, 2003 and assigned to Yahoo! Inc.

After identifying the terms that constitute the seed set, the semantically related term tool processes the terms of the seed set. Generally, for each term of the seed set, the semantically related term tool identifies concept terms of the seed set not including the term being processed and joins the term being processed with the identified concept terms.

For a first term of the seed set, the semantically related term tool identifies concept terms of the seed set that do not include the first term at step 306. Examples of systems and methods for identifying concept terms from a seed set are described in U.S. patent application Ser. No. 10/713,576 (now U.S. Pat. No. 7,051,023), filed Nov. 12, 2003 and assigned to Yahoo! Inc.

For example, when processing the term “N.Y. pizza” of the seed set “N.Y. pizza, fast delivery, cheap delivery,” the semantically related term tool identifies the concept terms associated with the second term “fast delivery” and the concept terms associated with the third term “cheap delivery.” The semantically related term tool determines the second term “fast delivery” includes the concept terms “fast,” “delivery,” and “fast delivery.” Similarly, the semantically related term tool determines the third term “cheap delivery” includes the concept terms “cheap,” “delivery,” and “cheap delivery.” Thus, the semantically related term tool identifies the concept terms of the seed set not including the term “N.Y. pizza” as “fast,” “delivery,” “fast delivery,” “cheap,” and “cheap delivery.”

It will be appreciated that in some implementations, as part of identifying concept terms, the semantically related term tool may remove any duplicate concept terms. For example, when identifying the concept terms associated with the second term “fast delivery” and the third term “cheap delivery,” the semantically related term tool will identify the concept term “delivery” associated with both the second term and the third term. However, the duplicate of the term “delivery” may be removed so that, as described below, the term “N.Y. pizza” is only joined with the term “delivery” once.

At step 308, the semantically related term tool joins the first term with each of the concept terms identified at step 306 to create a plurality of semantically related terms. Continuing with the example above, the semantically related term tool may join the term “N.Y. pizza” with each of the above-listed concept terms to create a plurality of semantically related terms including the terms “fast N.Y. pizza,” “N.Y. pizza delivery,” “N.Y. pizza fast delivery,” “cheap N.Y. pizza,” and “cheap N.Y. pizza delivery.”

The semantically related term tool determines if there are any remaining terms of the seed set to be processed at step 310. If the semantically related term tool determines there are remaining terms to be processed (312), the method 300 loops to step 306 where the above-described steps are repeated for the next term of the seed set. It will be appreciated that for each term of the seed set, the semantically related term tool identifies concept terms of the seed set that do not include the term being processed, joins the term being processed with each of the identified concept terms, and adds the resulting combined terms to the plurality of semantically related terms. For example, continuing with the example above, the above-described steps would be repeated for the terms “fast delivery” and “cheap delivery” to add additional terms to the plurality of semantically related terms.

Once the semantically related term tool determines all the terms of the seed set have been processed (314), the method 300 proceeds to step 315. In some implementations, at step 315, the semantically related term tool may remove any duplicate terms of the plurality of semantically related terms before proceeding to step 316. At step 316, the semantically related term tool may remove invalid terms from the plurality of semantically related terms based on a language model. For example, the semantically related term tool may remove each term of the plurality of semantically related terms associated with a search volume below a threshold. Typically a search volume is a number of times users have submitted a term to an Internet search engine in a defined period of time. By removing terms from the plurality of semantically related terms associated with a low search volume, the semantically related term tool removes terms that are likely invalid or meaningless.

After removing invalid terms such as terms associated with a low search volume, the semantically related term tool ranks at least a portion of the remaining terms of the plurality of semantically related terms at step 318. The semantically related term tool may rank the remaining terms of the plurality of semantically related terms based on one or more factors such as lexical features of a semantically related term, such as an edit distance or word edit distance between the semantically related term and one or more terms of the seed set; a degree of search overlap between a semantically related term and one or more terms of the seed set; advertiser attributes associated with a semantically related term and one or more terms of the seed set, such as bid price or advertiser depth; or any other metric that indicates a degree of semantical relationship between a semantically related term and one or more terms of the seed set.

Generally, an edit distance, also known as Levenshtein distance, is the smallest number of inserts, deletions, and substitutions of characters needed to change a semantically related term into one or more terms of the seed set, and word edit distance is the smallest number of insertions, deletions, and substitutions of words needed to change a semantically related term into one or more terms of the seed set. A degree of search overlap between a semantically related term and one or more terms of the seed set is a degree of similarity of search results resulting from a search at an Internet search engine for a semantically related term and a search at the Internet search engine for one or more terms of the seed set.

In one implementation, after ranking the plurality of semantically related terms at step 318, the semantically related term tool may export one or more of the top-ranked terms of the plurality of semantically related terms to an ad campaign management system and/or an ad provider at step 320 for use in a keyword suggestion tool or for use in keyword expansion. In another implementation, the semantically related term tool may export one or more of the top-ranked terms of the plurality of semantically related terms to a search engine at step 322 for use in broadening or focusing searches.

FIG. 4 illustrates a flow chart of another embodiment of a method for determining semantically related terms. The method 400 beings with a search engine, an ad provider, or an ad campaign management system receiving a seed set at step 402. As discussed above, the seed set includes two or more terms, each of which may include one or more words or phrases. The seed set may be a search query submitted to a search engine by an Internet user, a series of search queries submitted to a search engine by an Internet user related to similar concepts, a bidded phrase submitted by an advertiser interacting with an advertisement campaign management system of an ad provider, a keyword received from a website provider with an ad request, or any other set of terms submitted to a search engine, an ad provider, or an ad campaign management system.

The semantically related term tool identifies the terms that constitute the seed set at step 404. After identifying the seed set, the semantically related term tool processes each term of the seed set. Generally, for each term of the seed set, the semantically related term tool identifies concept terms of the seed set not including the term being processed, determines a plurality of concept terms based on combinations and permutations of the identified concept terms, determines combinations and permutations of the term being processed and the plurality of concept terms, and adds the resulting terms to a plurality of semantically related terms.

For a first term of the seed set, the semantically related term tool identifies the concept terms of the seed set that do not include the first term at step 406. The semantically related term tool then creates a plurality of concept terms at step 408 based on possible combinations and/or permutations of the concept terms identified at step 406.

Continuing with the example above regarding the seed set “N.Y. pizza, fast delivery, cheap delivery,” when processing the term “N.Y. pizza,” the semantically related term tool identifies the concept terms of the seed set not including the term “N.Y. pizza” as “fast,” “delivery,” “fast delivery,” “cheap,” and “cheap delivery.” The semantically related term tool then determines possible combinations and permutations of the above-listed concept terms to create a plurality of concept terms including the terms “fast,” “delivery,” “fast delivery,” “cheap,” “cheap delivery,” and “fast cheap delivery.” Thus, by determining possible combinations and permutations of the above-listed concept terms, the semantically related term tool discovers additional concept terms such as “fast cheap delivery” that are not identified in methods such as those described above with respect to FIG. 3 because the term “fast cheap delivery” is not a concept term of any term of the seed set. It will be appreciated that as seed sets include more terms, or the number of words or phrases that make up the terms of the seed set increases, the size of the created plurality of concept terms may grow at a great rate. Accordingly, in some implementations, the semantically related term tool may limit the size of the created plurality of concept terms.

The semantically related term tool then determines possible combinations and permutations of the first term and the plurality of concept terms at step 410, and adds the resulting terms to a plurality of semantically related terms at step 412. Continuing with the example above, the semantically related term tool determines possible combinations and permutations of the term “N.Y. pizza” and the above-listed terms of the plurality of concept terms, and adds resulting terms such as “fast N.Y. pizza,” “N.Y. pizza delivery,” “N.Y. pizza fast delivery,” “cheap N.Y. pizza,” “N.Y. pizza cheap delivery,” and “N.Y. pizza fast cheap delivery” to the plurality of semantically related terms.

The semantically related term tool determines if there are any remaining terms of the seed set to be processed at step 414. If the semantically related term tool determines there are remaining terms to be processed (416), the method 400 loops to step 406 where the above-described steps are repeated for the next term of the seed set. It will be appreciated that for each term of the seed set, the semantically related term tool identifies the concept terms of the seed that do not include the term being processed, determines possible combinations and permutations of the concept terms to create a plurality of concept terms, determines possible combinations and permutations of the term being processed and the determined plurality of concept terms, and adds the resulting terms to the plurality of semantically related terms. For example, continuing with the example above, the above-described steps would be repeated for the terms “fast delivery” and “cheap delivery” to add additional terms to the plurality of semantically related terms.

Once the semantically related term tool determines all the terms of seed set have been processed (418), the method 400 proceeds to step 419. At step 419, the semantically related term tool may remove any duplicate term from the plurality of semantically related terms before proceeding to step 420. At step 420, the semantically related term tool may remove invalid terms from the plurality of semantically related terms based on a language model. For example, the semantically related term tool may remove terms from the plurality of semantically related term tool based on whether a search volume associated with a term is below a threshold as described above. The semantically related term tool then ranks at least a portion of the remaining terms of the plurality of semantically related term at step 422 based on one or more factors such as lexical features of a semantically related term and one or more terms of the seed set; a degree of search overlap between a semantically related term and one or more terms of the seed set; advertiser attributes associated with a semantically related term and one or more terms of the seed set; or any other metric that indicates a degree of a semantical relationship between a semantically related term and one or more terms of the seed set.

In one implementation, after ranking the plurality of semantically related terms at step 422, the semantically related term tool may export one or more of the top-ranked terms of the plurality of semantically related terms to an ad campaign management system and/or an ad provider at step 424 for use in a keyword suggestion tool or for use in keyword expansion. In another implementation, the semantically related term tool may export one or more of the top-ranked terms of the plurality of semantically related terms to a search engine at step 426 for use in broadening or focusing searches.

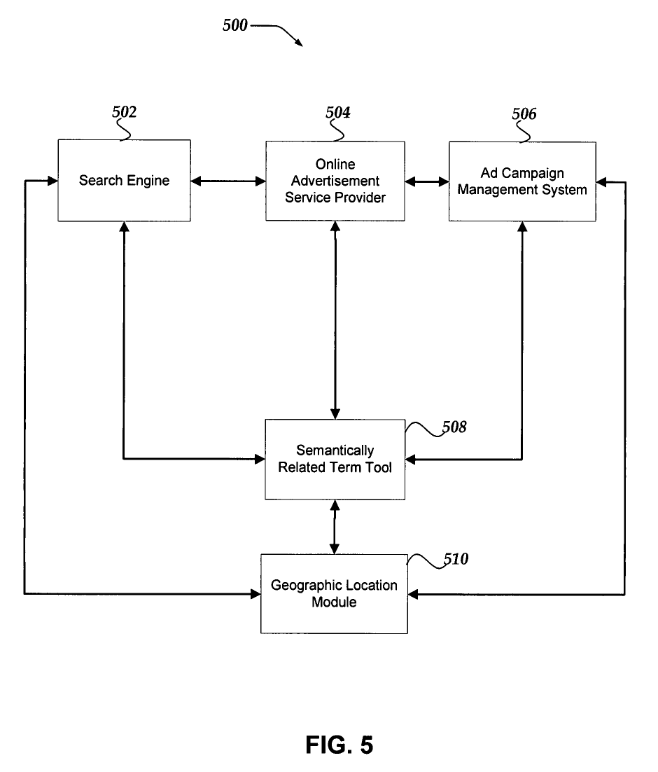

When a seed set received at a search engine or an ad provider includes an explicit geographic location, a semantically related term tool may desire to implement systems and methods to better determine terms semantically related to the seed set based on the explicit geographic location within the seed set. FIGS. 5-7 disclose systems and methods for determining semantically related terms based on an explicit geographic location within a received seed set.

FIG. 5 is a block diagram of another embodiment of a system for determining semantically related terms based on an explicit geographic location within a seed set. Like the system of FIG. 2, the system 500 may include a search engine 502, an ad provider 504, an ad campaign management system 506, and a semantically related term tool 508. The system may additionally include a geographic location module 510 in communication with the search engine 502, the ad provider 504, the ad campaign management system 508, and/or the semantically related term tool 508 for determining whether a term identifies a geographic location. The geographic location module 510 may be implemented as software code running in conjunction with a processor such as a single server, a plurality of servers, or any other type of computing device known in the art.

As described in more detail below, the search engine 502, the ad provider 504, or the ad campaign management system 506 receives a seed set. The semantically related term tool 508 identifies two or more terms that constitute the seed set and communicates with the geographic location module 510 to determine if any of the terms of the seed set identify an explicit geographic location. The semantically related term tool 508 removes any explicit geographic locations from the terms of the seed set to create a stripped seed set and determines a first plurality of semantically related terms using the terms of the stripped seed set and methods such as those described above with respect to FIGS. 3 and 4. The semantically related term tool 508 then combines each explicit geographic location determined above with each term of the first plurality of semantically related terms to create a second plurality of semantically related terms. Invalid or meaningless terms are removed from the second plurality of semantically related terms based on factors such as a search volume associated with each term of the second plurality of semantically related terms or a different explicit geographic location identified in a term of the second plurality of semantically related terms. The semantically related term tool then ranks at least a portion of the remaining terms of the second plurality of semantically related terms based on metrics indicating a degree of semantical relationship between a term of the second plurality of semantically terms and one or terms of the seed set.

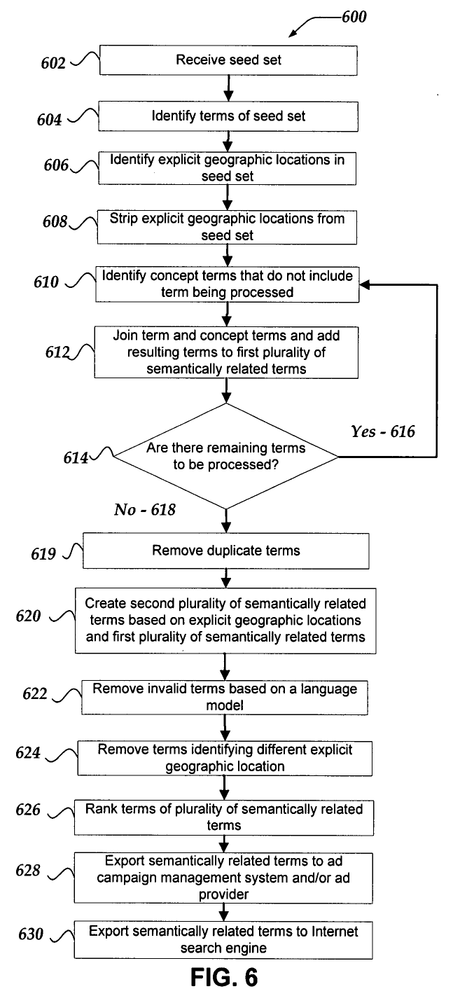

FIG. 6 illustrates a flow chart of one embodiment of a method for determining semantically related terms based on explicit geographic locations identified in a seed set. The method 600 begins with a search engine or an ad provider receiving a seed set at step 602. As discussed above, the seed set includes two or more terms, each of which includes one or more words or phrases. The seed set may be a search query submitted to a search engine by an Internet user, a series of search queries submitted to a search engine by an Internet user related to similar concepts, a bidded phrase submitted by an advertiser interacting with an advertisement campaign management system of an ad provider, a keyword received from a website provider with an ad request, or any other type of term submitted to a search engine, an ad provider, or an ad campaign management system.

The semantically related term tool identifies terms of the seed set at step 604 and communicates with a geographic location module to determine whether one or more of the terms of the seed set identify an explicit geographic location at step 606. Examples of systems and methods for determining whether a term identifies an explicit geographic location are disclosed in U.S. patent application Ser. No. 10/680,495, filed Oct. 7, 2003 and assigned to Yahoo! Inc. Generally, as described in U.S. patent application Ser. No. 10/680,495, to determine if a term identifies an explicit geographic location, the term is parsed into text including a name of a geographic location and text that does not include a name of a geographic location. The geographic location module then determines whether the term identifies an explicit geographic location based on factors such as one or more names of geographic locations in the term; whether for any of the names of geographic locations in the term, multiple geographic locations exist with the same name; relationships between any of the geographic locations named in the term; and relationships between the geographic locations named in the term and the text of the term that does not include a name of a geographic location.

It will be appreciated that the geographic location module does not indicate that a seed set identifies an explicit location when a geographic location within the seed set is used to describe a type of product. For example, for a term “N.Y. pizza delivery,” the geographic location module would not indicate that the term identifies an explicit geographic location because “N.Y.” is being used to describe a type of pizza. Conversely, for a term “Dayton pizza delivery,” the geographic location module indicates that the term identifies an explicit geographic location of “Dayton” because the geographic location is not being used to describe a type of pizza. At step 608, the semantically related term tool removes any explicit geographic locations determined at step 606 from the terms of the seed set to create a stripped seed set.

After removing the geographic locations from the seed set, the semantically related term tool processes terms of the stripped seed set. For each term of the stripped seed set, the semantically related term tool identifies the concept terms of the stripped seed set that do not include the term being processed, joins the term being processed with each of the concept terms, and adds the resulting combined terms to a first plurality of semantically related terms.

For a first term of the stripped seed set, the semantically related term tool identifies concept terms within the stripped seed set that do not include the first term at step 610. At step 612, the semantically related term tool then joins the first term with each of the concept terms identified at step 610 to create a first plurality of semantically related terms.

The semantically related term tool determines if there are any remaining terms of the stripped seed set to be processed at step 614. If the semantically related term tool determines there are remaining terms to be processed (616), the method 600 loops to step 610 where the above-described steps are repeated for the next term of the stripped seed set. Once the semantically related term tool determines each term of stripped seed set has been processed (618), the method 600 proceeds to step 619.

At step 619, the semantically related term tool may remove any duplicate terms of the first plurality of semantically related terms before proceeding to step 620. At step 620, the semantically related term tool joins each explicit geographic location determined at step 606 with each remaining term of the first plurality of semantically related terms to create a second plurality of semantically related terms. In some implementations, creating the second plurality of semantically related terms may include inserting prepositions such as “in” or “at” to join the geographic locations determined at step 606 with each term of the first plurality of semantically related terms. For example, when joining the term “hotels” with the explicit geographic location “Los Angeles,” the semantically related term tool may insert the preposition “in” so that the resulting term is “hotels in Los Angeles.”

The semantically related term tool removes invalid terms of the second plurality of semantically related terms based on a language model at step 622. For example, the semantically related term tool may remove each term of the second plurality of semantically related term associated with a search volume below a threshold at step 622. Additionally, at step 624 the semantically related term tool removes each term of the second plurality of semantically related terms associated with an explicit geographic location other than the geographic locations determined at step 606. In one implementation, the semantically related term tool communicates with the geographic location module to determine whether a term of the second plurality of semantically related terms identifies an explicit geographic location. If the term identifies an explicit geographic location, the explicit geographic location identified in the term is compared to the explicit geographic locations determined at step 608. If the explicit geographic location identified in the term is not related to one of the explicit geographic locations determined at step 606, the term is removed from the second plurality of semantically related term. For example the terms “Arlington Tex. tooth doctor” and “dentist” can create a second plurality of semantically related terms that includes terms such as “Arlington dentist.” While the term “Arlington dentist” is a valid term, the term likely refers to a dentist in Arlington, Va. rather than an intended dentist in Arlington, Tex. Therefore, the term “Arlington dentist” identifies an explicit geographic location other than one of the explicit geographic locations originally identified in the terms. Thus, the term “Arlington dentist” is removed.

The semantically related term tool ranks at least a portion of the remaining terms of the second plurality of semantically related terms at step 626. The semantically related term tool may rank at least a portion of the remaining terms based on one or more factors such as lexical features associated with a semantically related term and one or more terms of the seed set; a degree of search overlap between a semantically related term and one or more terms of the seed set; advertiser attributes associated with a semantically related term and one or more terms of the seed set; or any other metric that indicates a degree of a semantical relationship between a semantically related term and one or more terms of the seed set.

In one implementation, after ranking the terms of the second plurality of semantically related terms at step 628, the semantically related term tool may export one or more of the top-ranked terms of the second plurality of semantically related terms to an ad campaign management system and/or an ad provider at step 626 for use in a keyword suggestion tool or for use in keyword expansion. In another implementation, the semantically related term tool may export one or more of the top-ranked terms of the second plurality of semantically related terms to a search engine at step 628 for use in broadening or focusing searches.

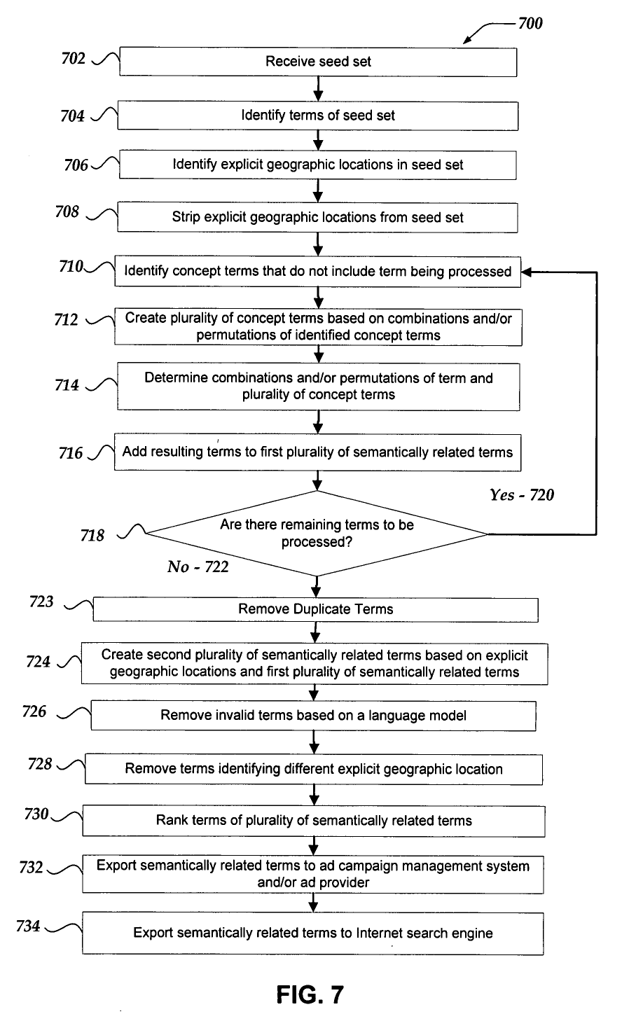

FIG. 7 is a flow chart of another embodiment of a method for determining semantically related terms based on explicit geographic locations identified in a seed set. The method 700 beings with a search engine, an ad provider, or an ad campaign management system receiving a seed set at step 702. As discussed above, the seed set includes two or more terms, each of which may include one or more words or phrases. The seed set may be a search query submitted to a search engine by an Internet user, a sequence of search queries submitted by an Internet user related to similar concepts, a bidded phrase submitted by an advertiser interacting with an advertisement campaign management system of an ad provider, a keyword received from a website provider with an ad request, or any other type of term submitted to a search engine, an ad provider, or an ad campaign management system.

The semantically related term tool identifies the terms that comprise the seed set at step 704 and communicates with a geographic location module to determine whether one or more of the terms of the seed set identify an explicit geographic location at step 706. At step 708, the semantically related term tool removes any explicit geographic locations determined at step 706 from the terms comprising the seed set to create a stripped seed set.

After removing the geographic locations from the seed set, the semantically related term tool processes the remaining terms of the stripped seed set. For each term of the stripped seed set, the semantically related term tool identifies concept terms of the stripped seed set that do not include the term being processed, determines possible combinations and permutations of the identified concept terms to create a plurality of concept terms, determines possible combinations and permutations of the term being processed and the plurality of concept terms, and adds the resulting terms to a first plurality of semantically related term.

For a first term of the stripped seed set, the semantically related term tool identifies concept terms in the stripped seed set that do not include the first term at step 710 and determines possible combinations and permutations of the concept terms to create a plurality of concept terms at step 712. The semantically related term tool then determines possible combinations and permutations of the first term and the plurality of concept terms at 714, and adds the resulting terms to a first plurality of semantically related terms at step 716.

The semantically related term tool determines if there are any remaining terms of the stripped seed set to be processed at step 718. If the semantically related term tool determines there are terms to be processed (720), the method 700 loops to step 710 where the above-described steps are repeated for the next term of the stripped seed set. Once the semantically related term tool determines there are no remaining terms to be processed (722), the method 700 proceeds to step 723.

At step 723, the semantically related term tool may remove any duplicate terms of the first plurality of semantically related terms before proceeding to step 724. At step 724, the semantically related term tool determines possible combinations and permutations of the explicit geographic location determined at step 706 and the terms of the first plurality of semantically related terms to create a second plurality of semantically related terms. In some implementations, creating the second plurality of semantically related terms may include inserting prepositions such as “in” or “at” to join the geographic locations determined at step 706 with each term of the first plurality of semantically related terms.

The semantically related term tool removes invalid terms from the second plurality of semantically related terms based on a language model at step 726. For example, the semantically related term tool may remove each term of the second plurality of semantically related terms associated with a search volume below a threshold at step 726. Additionally, at step 728 the semantically related term tool removes each term of the second plurality of semantically related terms that identifies an explicit geographic location that is not related to the explicit geographic locations determined at step 706.

The semantically related term tool ranks at least a portion of the remaining terms of the second plurality of semantically related terms at step 730. The semantically related term tool may rank the remaining terms based on one or more factors such as lexical features associated with a semantically related term and one or more terms of the seed set; a degree of search overlap between a semantically related term and one or more terms of the seed set; advertiser attributes associated with a semantically related term and one or more terms of the seed set; or any other metric that indicates a degree of semantical relationship between a semantically related term and one or more terms of the seed set.

In one implementation, after ranking the second plurality of semantically related terms at step 732, the semantically related term tool may export one or more of the top-ranked terms of the second plurality of semantically related terms to an ad campaign management system and/or an ad provider at step 734 for use in a keyword suggestion tool or for use in keyword expansion. In another implementation, the semantically related term tool may export one or more of the top-ranked terms of the second plurality of semantically related terms to a search engine at step 736 for use in broadening or focusing searches.

It should be appreciated that because in FIG. 7, a semantically related term tool determines a plurality of concept terms, a first plurality of semantically related terms, and a second plurality of semantically related terms based on possible combinations and permutations of different terms rather than a semantically related term tool joining terms to determine a first plurality of semantically related terms and a second plurality of semantically related terms such as described above with respect to FIG. 6, a semantically related term tool implementing methods such as those described with respect to FIG. 7 may determine terms semantically related to a seed set that a semantically related term tool implementing methods such as those described with respect to FIG. 6 would not identify.

FIGS. 1-7 disclose systems and methods for determining terms semantically related to a seed set. As described above, these systems and methods may be implemented for uses such as discovering semantically related words for purposes of bidding on online advertisements or to assist a searcher performing research at an Internet search engine.

With respect to assisting a searcher performing research at an Internet search engine, a searcher may send one or more terms, or one or more sequences of terms, to a search engine. The search engine may use the received terms as seed terms and suggest semantically related words related to the terms either with the search results generated in response to the received terms, or independent of any search results. Providing the searcher with semantically related terms allows the searcher to broaden or focus any further searches so that the search engine provides more relevant search results to the searcher.

With respect to online advertisements, in addition to providing terms to an advertiser in a keyword suggestion tool, an online advertisement service provider may use the disclosed systems and methods in a campaign optimizer component to determine semantically related terms to match advertisements to terms received from a search engine or terms extracted from the content of a webpage or news articles, also known as content match. Using semantically related terms allows an online advertisement service provider to serve an advertisement if the term that an advertiser bids on is semantically related to a term sent to a search engine rather than only serving an advertisement when a term sent to a search engine exactly matches a term that an advertiser has bid on. Providing the ability to serve an advertisement based on semantically related terms when authorized by an advertiser provides increased relevance and efficiency to an advertiser so that an advertiser does not need to determine every possible word combination for which the advertiser's advertisement is served to a potential customer. Further, using semantically related terms allows an online advertisement service provider to suggest more precise terms to an advertiser by clustering terms related to an advertiser, and then expanding each individual concept based on semantically related terms.

An online advertisement service provider may additionally use semantically related terms to map advertisements or search listings directly to a sequence of search queries received at an online advertisement service provider or a search engine. For example, an online advertisement service provider may determine terms that are semantically related to a seed set including two or more search queries in a sequence of search queries. The online advertisement service provider then uses the determined semantically related terms to map an advertisement or search listing to the sequence of search queries.

It is therefore intended that the foregoing detailed description be regarded as illustrative rather than limiting, and that it be understood that it is the following claims, including all equivalents, that are intended to define the spirit and scope of this invention.

1. A method for determining semantically related terms, the method comprising:
identifying two or more terms of a seed set;
identifying concept terms associated with terms of the seed set other than a first term of the seed set; and
joining the first term with the identified concept terms associated with terms of the seed set other than the first term.

2. The method of claim 1, further comprising:
adding resulting terms of the joining of the first term with the identified concept terms associated with terms of the seed set other than the first term to a plurality of semantically related terms; and
ranking at least a portion of the plurality of semantically related terms based on a metric indicating a degree of semantical relationship between a term of the plurality of semantically related terms and one or more terms of the seed set.

3. The method of claim 2, further comprising:
removing each term from the plurality of semantically related terms associated with a search volume below a threshold.

4. The method of claim 2, further comprising:
identifying concept terms associated with terms of the seed set other than a second term of the seed set;
joining the second term with the identified concept terms associated with terms of the seed set other than the first set; and
adding resulting terms of the joining of the second term with the identified concept terms associated with terms of the seed set other than the second term to the plurality of semantically related terms.

5. The method of claim 2, further comprising:
providing at least one of the plurality of semantically related terms to a user based on the ranking of the plurality of semantically related terms.

6. The method of claim 2, further comprising:
exporting at least one of the plurality of semantically related terms to an Internet search engine based on the ranking of the plurality of semantically related terms.

7. The method of claim 2, further comprising:
exporting at least one of the plurality of semantically related terms to an online advertisement service provider based on the ranking of the plurality of semantically related terms.

8. The method of claim 2, wherein the plurality of semantically related terms are ranked based on a lexical feature of each term of the plurality of semantically related term and one or more terms of the seed set.

9. The method of claim 8, wherein the lexical feature is an edit distance between a term of the plurality of semantically related terms and one or more terms of the seed set.

10. The method of claim 8, wherein the lexical feature is a word edit distance between a term of the plurality semantically related terms and one or more terms of the seed set.

11. A computer-readable storage medium comprising a set of instructions for determining semantically related terms, the set of instructions to direct a processor to perform acts of:
identifying two or more terms of a seed set;
identifying concept terms associated with terms of the seed set other than a first term of the seed set; and
joining the first term with the identified concept terms associated with terms of the seed set other than the first term.

12. The computer-readable storage medium of claim 11, further comprising a set of instructions to direct a processor to perform acts of:
adding resulting terms of the joining of the first term with the identified concept associated with terms of the seed set other than the first term to a plurality of semantically related terms; and
ranking at least a portion of the plurality of semantically related terms based on a metric indicating a degree of semantical relationship between a term of the plurality of semantically related terms and one or more terms of the seed set.

13. The computer-readable storage medium of claim 12, further comprising a set of instructions to direct a processor to perform acts of:
removing each term from the plurality of semantically related terms associated with a search volume below a threshold.

14. The computer-readable storage medium of claim 12, further comprising a set of instructions to direct a processor to perform acts of:
identifying concept terms associated with terms of the seed set other than a second term of the seed set;
joining the second term with the identified concept terms associated with terms of the seed set other than the first set; and
adding resulting terms of the joining of the second term with the identified concept terms associated with terms of the seed set other than the second term to the plurality of semantically related terms.

15. The computer-readable storage medium of claim 12, further comprising a set of instructions to direct a processor to perform acts of:
providing at least one of the plurality of semantically related terms to a user based on the ranking of the plurality of semantically related terms.

16. The computer-readable storage medium of claim 12, further comprising a set of instructions to direct a processor to perform acts of:
exporting at least one of the plurality of semantically related terms to an Internet search engine based on the ranking of the plurality of semantically related terms.

17. The computer-readable storage medium of claim 12, further comprising a set of instructions to direct a processor to perform acts of:
exporting at least one of the plurality of semantically related terms to an online advertisement service provider based on the ranking of the plurality of semantically related terms.

18. A system for determining semantically related terms, the system comprising:
a semantically related term tool operative to identify two or more terms of a seed set, to identify concept terms associated with terms of the seed set other than a first term of the seed set; and to join the first term with the identified concept terms associated with terms of the seed set other than the first term.

19. The system of claim 18, wherein the semantically related term tool is further operative to add resulting terms of the joining of the first term with the identified concept terms associated with terms of the seed set other than the first term to a plurality of semantically related terms, and to rank a least a portion of the plurality of semantically related terms based on a metric indicating a degree of semantical relationship between a term of the plurality of semantically related terms and one or more terms of the seed set.

20. The system of claim 19, wherein the semantically related term tool is in communication with an Internet search engine, and the semantically related term tool is operative to receive the seed set from the Internet search engine and to export at least one term of the plurality of semantically related terms to the Internet search engine based on the ranking of the plurality of semantically related terms.

21. The system of claim 18, wherein the semantically related term tool is in communication with an online advertisement service provider and the semantically related term tool is operative to receive the seed set from the online advertisement service provider and to export at least one term of the plurality of semantically related terms to the online advertisement service provider based on the ranking of the plurality of semantically related terms.

22. A method for determining semantically related terms, the method comprising:
identifying two or more terms of a seed set;
identifying one or more explicit geographic locations identified in the seed set;
removing the identified explicit geographic locations from the terms of the seed set to create a stripped seed set;
identifying concept terms associated with terms of the stripped seed set other than a first term of the stripped seed set;
joining the first term with the identified concept terms associated with terms in the stripped seed set other than the first term;
adding resulting terms of the joining of the first term with the identified concept terms associated with terms in the stripped seed set other than the first term to a first plurality of semantically related terms; and
joining a first explicit geographic location of the one or more identified geographic locations with terms of the first plurality of semantically related terms.

23. The method of claim 22, further comprising:
adding resulting terms of the joining of the first explicit geographic location and terms of the first plurality of semantically related terms to a second plurality of semantically related terms; and
ranking at least a portion of the second plurality of semantically related terms based on a metric indicating a degree of semantical relationship between a term of the second plurality of semantically related terms and one or more terms of the seed set.

24. The method of claim 23, further comprising:
removing invalid terms from the second plurality of semantically related terms based on language model.

25. The method of claim 23, further comprising:
removing each term of the second plurality of semantically related terms identifying an explicit geographic location that is not associated with one of the identified geographic locations.

26. The method of claim 23, further comprising:
joining a second explicit geographic location of the one or more identified geographic locations with terms of the first plurality of semantically related terms; and
adding resulting terms of the joining of the second explicit geographic location with terms of the first plurality of semantically related terms to the second plurality of semantically related terms.

27. The method of claim 22, further comprising:
identifying concept terms associated with terms of the stripped seed set other than a second term of the stripped seed set;
joining the second term with the identified concept terms associated with terms in the stripped seed set other than the second term; and
adding resulting terms of the joining of the second term with the identified concept terms associated with terms in the stripped seed set other than the second term to the first plurality of semantically related terms.

28. A computer-readable storage medium comprising a set of instructions for determining semantically related terms, the set of instructions to direct a processor to perform acts of:
identifying two or more terms of a seed set;
identifying one or more explicit geographic locations identified in the seed set;
removing the identified explicit geographic locations from the terms of the seed set to create a stripped seed set;
identifying concept terms associated with terms of the stripped seed set other than a first term of the stripped seed set;
joining the first term with the identified concept terms associated with terms in the stripped seed set other than the first term;
adding resulting terms of the joining of the first term with the identified concept terms associated with terms in the stripped seed set other than the first term to a first plurality of semantically related terms; and
joining a first explicit geographic location of the one or more identified geographic locations with terms of the first plurality of semantically related terms.

29. The computer-readable storage medium of claim 28, further comprising a set of instructions to direct a processor to perform acts of:
adding resulting terms of the joining of the first explicit geographic location and terms of the first plurality of semantically related terms to a second plurality of semantically related terms; and
ranking at least a portion of the second plurality of semantically related terms based on a metric indicating a degree of semantical relationship between a term of the second plurality of semantically related terms and one or more terms of the seed set.

30. The computer-readable storage medium of claim 29, further comprising a set of instructions to direct a processor to perform acts of:
removing each invalid terms of the second plurality of semantically related terms based on a language model; and
removing each term of the second plurality of semantically related terms identifying an explicit geographic location that is not associated with one of the identified geographic locations.
